(19) United States
(12) Patent Application Publication
(10) Pub. No.: US 2004/0168249 A1
(43) Pub. Date: Sep. 2, 2004

(54) Whirlpool bath jet assembly with drainage feature

(76) Inventors: Wilfried B. Gerth, La Mirada, CA (US); Chris H. McDonald, Yorba Linda, CA (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/723,310

(22) Filed: Nov. 26, 2003

Related U.S. Application Data
(60) Provisional application No. 60/451,355, filed on Feb. 28, 2003.

(51) Int. Cl. A61H 33/04

(52) U.S. Cl. 4/541.6

(57) ABSTRACT

A whirlpool bath jet assembly (100 100′) featuring a water supply pipe inlet (1) having a jet body (7) with a drainage path and channel (8) recessed below a directional eyeball nozzle flow control valve assembly (4) for draining excess water through multiple drainage paths (16) in a wall fitting (11) that holds the jet body (7) on a wall (19).

### CROSS REFERENCE TO RELATED APPLICATION

Reference is made to and priority claimed from U.S. provisional application Ser. No. 60/451,355, filed Feb. 28, 2003, and entitled WHIRLPOOL BATH JET ASSEMBLY WITH DRAINAGE FEATURE.

### TECHNICAL FIELD

The present invention pertains to the field of hydromassage fittings and, more particularly, to hydromassage fittings adapted to inject an aerated water jet into a bathtub, spa, whirlpool, swimming pool or the like.

### BACKGROUND ART

In a whirlpool bathtub, which uses jets to provide a whirlpool, it is advantageous to reduce the amount of water a plumbing system and all its components retain after the bathtub is drained because water left in place for a period of time can serve as a breeding ground for bacteria. Jets located in the so-called lumbar region of a whirlpool bathtub (i.e. the region where the lower back of a person would rest) are particularly prone to retaining water (due to the angle of the bathtub wall in the lumbar region).

In addition to concerns over retained water in jets in general, there are basically two types of plumbing arrangements used by the whirlpool bathtub industry—the so-called “stacked” and “manifold” types, and the two types of arrangements cause water to be retained in different ways, and so in general demand different kinds of jets. The stacked arrangement is a series type of plumbing arrangement and the manifold arrangement is a parallel type of plumbing arrangement.

What is needed is a jet design that ideally allows water to drain (out of the jet, after the water supply is turned off) in both the stacked and manifold plumbing arrangements.

### DISCLOSURE OF THE INVENTION

Accordingly, in a first aspect of the invention, a whirlpool bath jet assembly is provided having a water supply pipe inlet with a jet body having a directional eyeball nozzle flow control valve assembly arranged in the jet body, characterized in that: the jet body is formed as a single integral body having a drainage path or channel recessed below the directional eyeball nozzle flow control valve assembly and disposed so as to be in communication with at least one drainage path in a wall fitting, for draining excess water through the at least one drainage path in the wall fitting.

In accord with the first aspect of the invention, the face plate may be secured to the jet body by threaded features and the multiple drainage paths may be circumferentially arranged around the periphery of the wall fitting.

Also in accord with the first aspect of the invention, the water supply pipe inlet may have a substantially slanted wall leading to the jet body so as to allow draining the excess water.

Also in accord with the first aspect of the invention, the water supply pipe inlet may be arranged above a water passage of the directional eyeball nozzle flow control valve assembly. Further, the water passage may be substantially slanted so as to allow draining the excess water.

Also in accord with the first aspect of the invention, the whirlpool bath jet assembly may have a wall fitting for securing the jet body against a bathtub wall.

Also in accord with the first aspect of the invention, the directional eyeball nozzle flow control valve assembly may have an articulating nozzle ball having a directional adjustable valve arranged therein. Further the articulating nozzle ball may have a circumferential slot for receiving multiple snap fit features of the directional adjustable valve. Also further, the articulating nozzle ball may have two corresponding pivot arms for residing in two channels of the jet body for preventing the articulating nozzle ball from rotating about a directional flow control axis of the directional eyeball nozzle flow control valve assembly during flow control valve actuation.

Also in accord with the first aspect of the invention, the water supply pipe inlet may have an air supply nozzle arranged therein. Further, the water supply pipe inlet and the air supply nozzle may provide water and air respectively to a mixing chamber of the directional eyeball nozzle flow control valve assembly. Also further, the air supply nozzle may be a stacked air supply nozzle with a pipe socket for a “series” style of air connection, or may be a manifold air supply nozzle with a barbed fitting for receiving a flexible tube attachment for a “parallel” style of air connection. Also further, the water supply pipe inlet and the air supply nozzle may have corresponding snap features to positionally retain the air supply nozzle in the water supply pipe inlet. Further still, the water supply pipe inlet and the air supply nozzle may also have corresponding indexing features to positionally locate the air supply nozzle in relation to the directional eyeball nozzle flow control valve assembly.

In a second aspect of the invention, a method is provided by which a whirlpool bath jet assembly having a water supply pipe inlet with a jet body and having a directional eyeball nozzle flow control valve assembly arranged in the jet body, is provided so as to be able to drain retained water, characterized by: providing the jet body formed as a single integral body having a drainage path or channel recessed below the directional eyeball nozzle flow control valve assembly and disposed so as to be in communication with at least one drainage path in a wall fitting; thereby making possible draining excess water from the whirlpool bath jet assembly through the at least one drainage path in the wall fitting.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a dry jet stacked version cross sectional view.

FIG. 2 is a dry jet manifold version cross sectional view.

FIG. 3 is a directional eyeball flow control valve assembly exploded isometric view.

FIG. 4 is a directional eyeball flow control valve assembly longitudinal section view.

FIG. 5 is an escutcheon front isometric view.

FIG. 6 is an escutcheon rear isometric view.

FIG. 7 is a jet body isometric view.

FIG. 8 is a stacked air nozzle isometric view.

FIG. 9 is a manifold air nozzle isometric view.

### DETAILED DESCRIPTION OF THE INVENTION

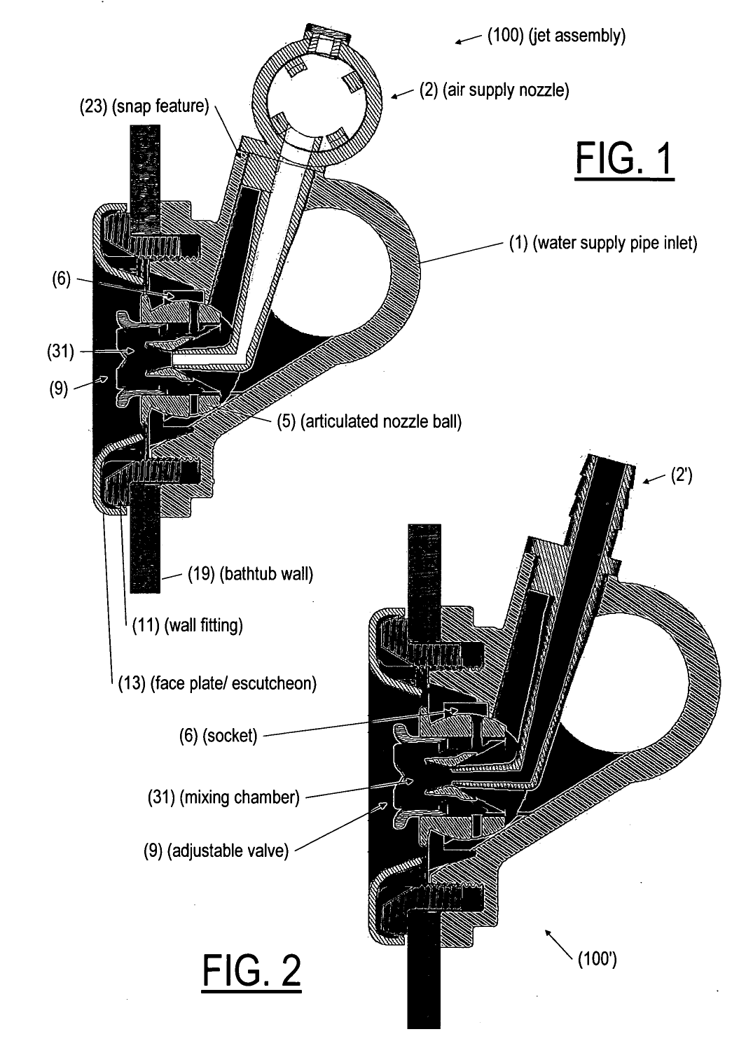

Referring now to FIGS. 1 and 2, so as to allow draining of a jet assembly (100 100′) (used for example in a whirlpool bath) after turning off its source of water, the invention provides a jet assembly including a water supply pipe inlet (1) having a jet body (7) with a drainage path and channel (8) recessed below a directional eyeball nozzle flow control valve assembly (4) for draining excess water through multiple drainage paths (16) in a wall fitting (11).

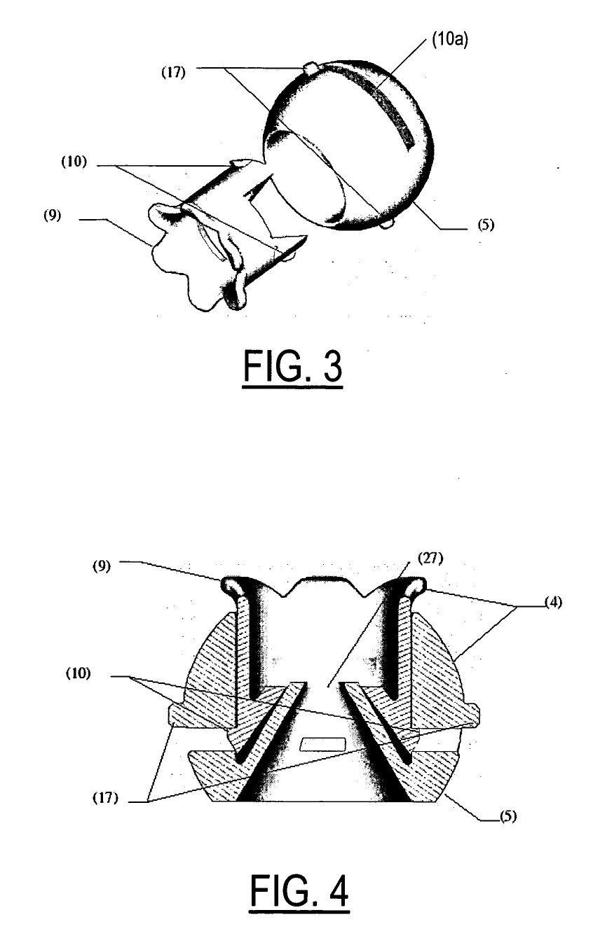

Still referring to FIGS. 1 and 2 and now also to FIGS. 3 and 4, the invention incorporates the water supply pipe inlet (1) and an air supply nozzle (2 2′), which deliver water and air respectively to a mixing chamber (3) of the directional eyeball nozzle flow control valve assembly (4). The directional eyeball nozzle flow control valve assembly (4) includes an articulated nozzle ball (5) residing in a socket (6) of the jet body (7). The jet body socket (6) retains the articulated nozzle ball (5) by means of a controlled fit within walls of the jet body socket (6). The drainage path and channel (8) is provided below the articulated nozzle ball (5) in the jet body (7). A directional adjustable valve (9) attaches to the articulated nozzle ball (5) via multiple snap fit features (10) that snap into a circumferential slot (10a) in the articulated nozzle ball (5), and can be used to adjust the rate of flow of water through a water passageway (27).

The configuration of the articulated nozzle ball (5) is such that the brunt of the retention force for the directional eyeball nozzle flow control valve assembly (4) is borne by the articulated nozzle ball (5). Such a configuration makes adjusting the flow rate rather easy using the directional adjustable valve (9), even under full operational pressures. The jet body (7) is configured so that the water inlet (1) and air inlet via the air supply nozzle (2 2′) are relatively high above the water passageway (27), which has a slanted wall (28) so as to allow drainage even for angles encountered in the lumbar region of the tub, i.e. even when the jet is used in a lumbar region of the tub.

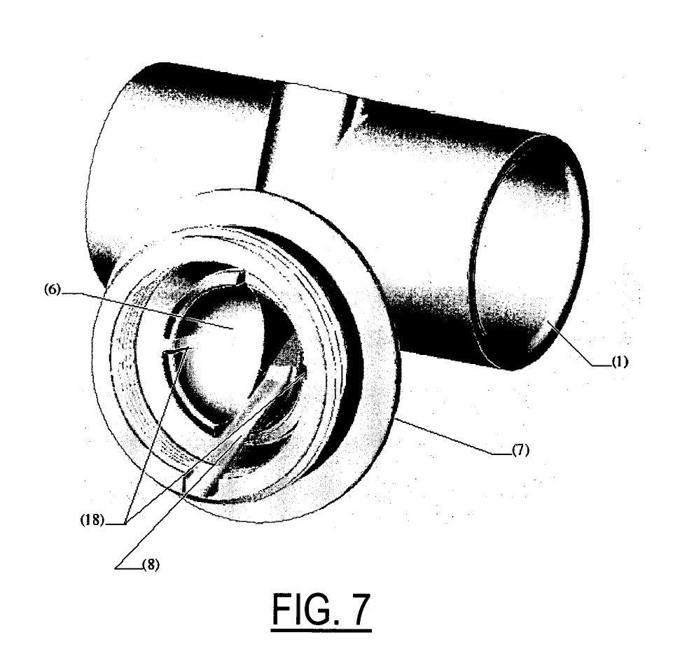

Referring still to FIGS. 1-4, the directional adjustable valve multiple snap fit features (10) are spherically configured to reduce the area of sliding contact with the articulated nozzle ball (5) to further reduce the torque due to friction required to adjust the flow under full operational pressure. The articulated nozzle ball (5) has two pivot arms (17) (FIG. 3) that reside in two channels (18) (FIG. 7) in the jet body (7). The pivot arms (17) prevent the articulated nozzle ball (5) from rotating about the directional eyeball nozzle flow control valve assembly (4) axis while the flow control valve is adjusted.

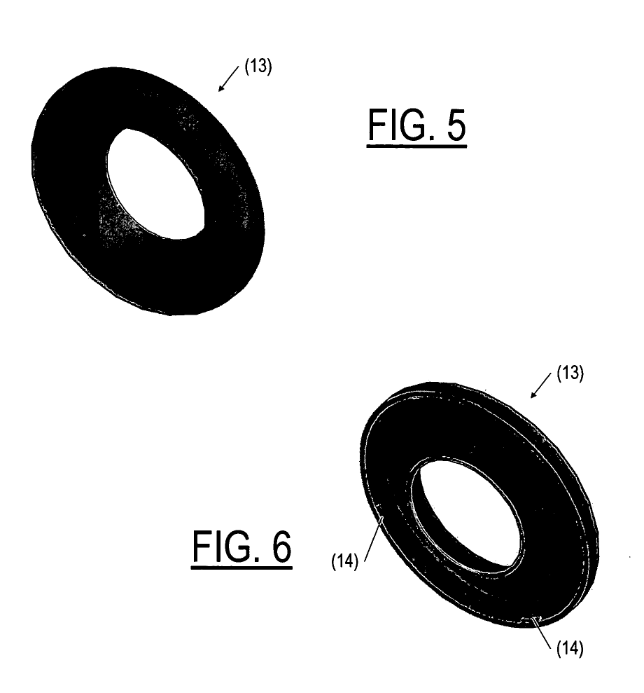

Referring now to FIGS. 1 and 2 and also to FIGS. 5 and 6, the escutcheon/ face plate (13) is secured to the jet body (7) by clip features (14).

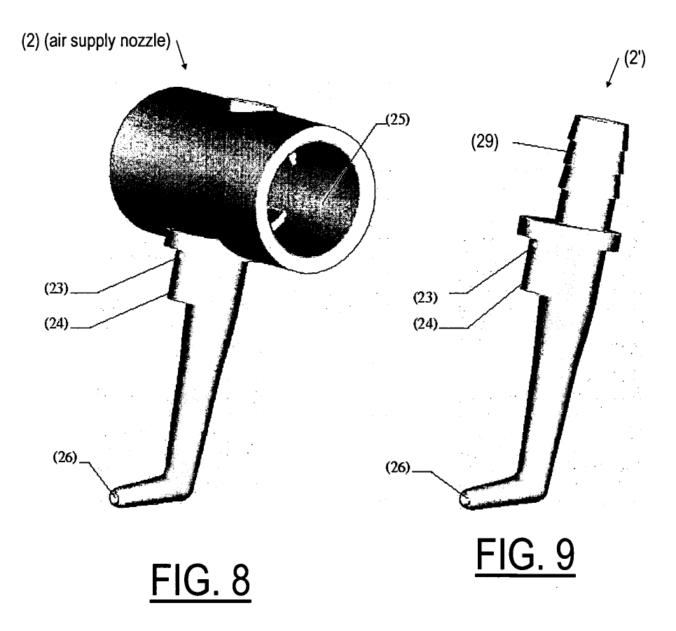

Referring again to FIGS. 1-2 and now also to FIGS. 8-9, the invention provides unique stacked and manifold design change configurability. The air nozzle (2) (FIGS. 1 and 8) for a stacked design has an ASTM standard plastic pipe socket (25) for a “series” style of air connection. The air nozzle (2′) (FIGS. 2 and 9) for a manifold design has a barb fitting (29) for a flexible tube attachment for a “parallel” style of air connection. Both types of air nozzles (2 2′) and the jet body (7) are configured with snap features (23) to positionally retain the air nozzles (2 2′) during glue setup time. Both air nozzles (2 2′) are also configured with an indexing feature (24) to positionally locate the air nozzle exit (26) relative to the directional eyeball flow control valve assembly entrance (27).

The invention thus overcomes water retention in a jet by inclining all the bottom surfaces inside the jet once the water has left the main pipe area (through which water is provided to the jet) so that all the water in the jet will drain (from gravity) along drainage paths provided by the invention, even if the jet is mounted in the lumbar region of a whirlpool bathtub. The drainage paths are provided in the places where water retention is most likely. In addition to drainage paths, the invention provides valve openings located so that all water within the valves of the jet will also drain. Also, the functions of the directional eyeball, nozzle, and flow control valve are combined into a single component to minimize the different components that could retain water.

The invention also addresses the plumbing arrangements by combining the air nozzle with the air plumbing type (FIG. 2 illustrates a combined plumbing type in that the water side can also be stacked or manifold), so that the jet plumbing type can be reconfigured based on a bathtub manufacturer's needs at the time of plumbing integration (since the jet body can be stocked without the air nozzle attached so that the air connection type can be configured at the time of tub assembly instead of well before), giving the manufacturer flexibility in ordering jet components.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A whirlpool bath jet assembly having a water supply pipe inlet (1) with a jet body (7) having a directional eyeball nozzle flow control valve assembly (4) arranged in the jet body (7), characterized in that:
the jet body (7) is formed as a single integral body having a drainage path or channel (8) recessed below the directional eyeball nozzle flow control valve assembly (4) and disposed so as to be in communication with at least one drainage path (16) in a wall fitting (11), for draining excess water through the at least one drainage path (16) in the wall fitting (11).

2. A whirlpool bath jet assembly according to claim 1, wherein the face plate (13) is secured to the jet body (7) by threaded features (14) and the multiple drainage paths (16) are circumferentially arranged around the periphery of the wall fitting (11).

3. A whirlpool bath jet assembly according to claim 1, wherein the water supply pipe inlet (1) has a substantially slanted wall (28) leading to the jet body (7) so as to allow draining the excess water.

4. A whirlpool bath jet assembly according to claim 1, wherein the water supply pipe inlet (1) is arranged above a water passage (27) of the directional eyeball nozzle flow control valve assembly (4).

5. A whirlpool bath jet assembly according to claim 4, wherein the water passage (27) is substantially slanted so as to allow draining the excess water.

6. A whirlpool bath jet assembly according to claim 1, wherein the whirlpool bath jet assembly (1) has a wall fitting (11) for securing the jet body (7) against a bathtub wall (19).

7. A whirlpool bath jet assembly according to claim 1, wherein the directional eyeball nozzle flow control valve assembly (4) has an articulating nozzle ball (5) having a directional adjustable valve (9) arranged therein.

8. A whirlpool bath jet assembly according to claim 7, wherein the articulating nozzle ball (5) has a circumferential slot (10a) for receiving multiple snap fit features (10) of the directional adjustable valve (9).

9. A whirlpool bath jet assembly according to claim 7, wherein the articulating nozzle ball (5) has two corresponding pivot arms (17) for residing in two channels (18) of the jet body (7) for preventing the articulating nozzle ball (5) from rotating about a directional flow control axis of the directional eyeball nozzle flow control valve assembly (4) during flow control valve actuation.

10. A whirlpool bath jet assembly according to claim 1, wherein the water supply pipe inlet (1) has an air supply nozzle (2 2′) arranged therein.

11. A whirlpool bath jet assembly according to claim 10, wherein the water supply pipe inlet (1) and the air supply nozzle (2 2′) provide water and air respectively to a mixing chamber (3) of the directional eyeball nozzle flow control valve assembly (4).

12. A whirlpool bath jet assembly according to claim 10, wherein the air supply nozzle (2) is a stacked air supply nozzle with a pipe socket (25) for a “series” style of air connection.

13. A whirlpool bath jet assembly according to claim 10, wherein the air supply nozzle (2′) is a manifold air supply nozzle with a barbed fitting (26) for receiving a flexible tube attachment for a “parallel” style of air connection.

14. A whirlpool bath jet assembly according to claim 10, wherein the water supply pipe inlet (1) and the air supply nozzle (2 2′) have corresponding snap features (23) to positionally retain the air supply nozzle (2 2′) in the water supply pipe inlet (1).

15. A whirlpool bath jet assembly according to claim 14, wherein the water supply pipe inlet (1) and the air supply nozzle (2 2′) also have corresponding indexing features (24) indexed to positionally locate the air supply nozzle (2 2′) in relation to the directional eyeball nozzle flow control valve assembly (4).

16. A method by which a whirlpool bath jet assembly having a water supply pipe inlet (1) with a jet body (7) and having a directional eyeball nozzle flow control valve assembly (4) arranged in the jet body (7), is provided so as to be able to drain retained water, characterized by:
providing the jet body (7) formed as a single integral body having a drainage path or channel (8) recessed below the directional eyeball nozzle flow control valve assembly (4) and disposed so as to be in communication with at least one drainage path (16) in a wall fitting (11);
thereby making possible draining excess water from the whirlpool bath jet assembly through the at least one drainage path (16) in the wall fitting (11).
